(19) United States
(12) Patent Application Publication
(10) Pub. No.: US 2026/0276563 A1
(43) Pub. Date: Sep. 17, 2026

(54) MATERIAL INSPECTION AND TESTING PROCESS USING A RADIO OPAQUE PENETRANT

(71) Applicant: Illinois Tool Works Inc., Glenview, IL (US)

(72) Inventors: Brian Pauley, Eldridge, IA (US); Lisa Barkand, Chicago, IL (US); Jana Sterk, Barrington, IL (US)

(21) Appl. No.: 19/568,211

(22) Filed: Mar. 16, 2026

Related U.S. Application Data
(60) Provisional application No. 63/773,181, filed on Mar. 17, 2025.
(60) Provisional application No. 63/773,172, filed on Mar. 17, 2025.

(51) Int. Cl. G01N 23/046; G01M 3/20

(52) U.S. Cl. CPC G01N 23/046; G01M 3/20; G01N 2223/1016; G01N 2223/419; G01N 2223/646; G01N 2223/647

(57) ABSTRACT

The present disclosure relates generally to a method for inspecting and testing parts using a radio opaque penetrant formulation. The method may comprise the steps of providing a part for inspecting and testing, applying a radio opaque penetrant formulation to a part to be tested, waiting a period of time to allow the radio opaque penetrant formulation to penetrate into the part, and scanning the part using an X-ray CT scanner. The radio opaque penetrant formulation may comprise a penetrating liquid and a radio opaque material. The penetrating liquid may be fluorescent or non-fluorescent.

### RELATED APPLICATIONS

The present application claims the benefit of U.S. Provisional Patent Application Ser. No. 63/773,181, filed Mar. 17, 2025, entitled “MATERIAL INSPECTION AND TESTING PROCESS USING A RADIO OPAQUE PENETRANT,” and of U.S. Provisional Patent Application Ser. No. 63/773,172, filed Mar. 17, 2025, entitled “RADIO OPAQUE PENETRANT FORMULATION FOR MATERIAL TESTING,” The entirety of U.S. Provisional Patent Application Ser. No. 63/773,181 is expressly incorporated herein by reference.

### FIELD

The present disclosure relates generally to a method for inspecting and testing parts using a radio opaque penetrant formulation.

### BACKGROUND

Liquid penetrants (“penetrating liquids”) are low-viscosity, high surface-tension fluids which often contain dyes. The liquid penetrants are drawn into flaws such as cracks and other discontinuities by strong capillary action. Liquid penetrants may be used to find small flaws or defects in safety-critical components, including in investment castings, jet engine parts, automotive parts, and other highly machined surfaces. There exists a need for an improved method for material inspection using a liquid penetrant with greater contrast to allow for better and more accurate imaging of flaws and defects.

### SUMMARY

According to an aspect of the present disclosure, a method for inspecting and testing a part using a radio opaque penetrant formulation may comprise the steps of: (a) providing a part for inspecting and testing; (b) applying a radio opaque penetrant formulation to a part to be tested; (c) waiting a period of time to allow the radio opaque penetrant formulation to penetrate into the part; and (d) scanning the part using an X-ray CT scanner. The radio opaque penetrant formulation may comprise a penetrating liquid and a radio opaque material. The method may further comprise, prior to applying the radio opaque penetrant formulation in step (b), steps of: precleaning the part with a cleaning solution; and drying the part. The method may further comprise, subsequent to waiting in step (c), a step of removing excess radio opaque penetrant formulation. The method may further comprise, prior to scanning in step (d), a step of rinsing the part.

It is to be understood that both the foregoing general description and the following detailed description describe various embodiments and are intended to provide an overview or framework for understanding the nature and character of the claimed subject matter. The accompanying drawings are included to provide a further understanding of the various embodiments, and are incorporated into and constitute a part of this specification. The drawings illustrate the various embodiments described herein, and together with the description serve to explain the principles and operations of the claimed subject matter.

### BRIEF DESCRIPTION OF THE DRAWINGS

The following is a description of the examples depicted in the accompanying drawings. The figures are not necessarily to scale, and certain features and certain views of the figures may be exaggerated in scale or in schematic for clarity or conciseness.

FIG. 1 illustrates a flow chart showing an example method for preparing a radio opaque penetrant formulation according to the present disclosure.

FIG. 2 illustrates an X-ray CT scan of a solder joint between a brass fixture and a copper pipe.

FIG. 3 illustrates an X-ray CT scan of a turbine blade.

FIG. 4A illustrates an X-ray CT scan of a rotor vane.

FIG. 4B illustrates another X-ray CT scan of the same rotor vane, imaged several microns down from the image shown in FIG. 4A.

The foregoing summary, as well as the following detailed description, will be better understood when read in conjunction with the figures. It should be understood that the claims are not limited to the arrangements and instrumentality shown in the figures. Furthermore, the appearance shown in the figures is one of many ornamental appearances that can be employed to achieve the stated functions of the apparatus.

### DETAILED DESCRIPTION

In the following detailed description, specific details may be set forth to provide a thorough understanding of the embodiments of the present disclosure. However, it will be clear to one skilled in the art when disclosed examples may be practiced without some or all of these specific details. For the sake of brevity, well-known features or processes may not be described in detail. In addition, like or identical reference numerals may be used to identify common or similar elements.

One or more specific embodiments of the present disclosure will be described below. In an effort to provide a concise description of these embodiments, all features with an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” “the,” and “said” are intended to mean that there are one or more of the elements. The terms “comprising,” “including,” and “having” are intended to be inclusive and mean that there may be additional elements other than the listed elements.

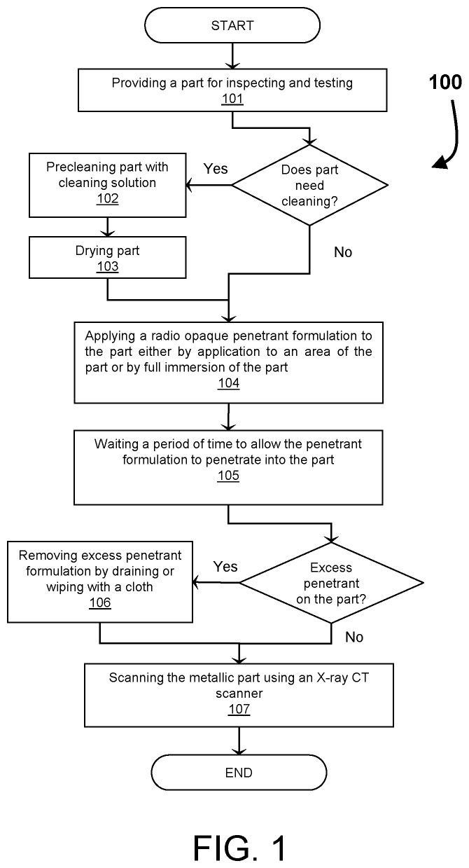

According to an aspect of the present disclosure, a method for inspecting and testing a part using a radio opaque penetrant formulation may comprise steps shown in FIG. 1 of: (a) providing a part for inspecting and testing 101; (b) applying a radio opaque penetrant formulation to a part to be tested 102; (c) waiting a period of time to allow the radio opaque penetrant formulation to penetrate into the part 105; and (d) scanning the part using an X-ray CT scanner 107. The scanning may involve conducting a 2-dimensional or a 3-dimensional X-ray scan. As shown in FIG. 1, in situations where the part needs cleaning prior to applying the radio opaque penetrant formulation, the method may further comprise, prior to applying the radio opaque penetrant formulation in step 104, steps of: precleaning the part with a cleaning solution 102; and drying the part 103. As shown in FIG. 1, in situations where there is excess penetrant on the part, the method may further comprise, subsequent to waiting in step 105, a step of removing excess radio opaque penetrant formulation. Although it is not shown in FIG. 1, the method may further comprise, prior to scanning in step 107, a step of rinsing the part. Such a rinsing step could be part of the step 106 of removing excess penetrant.

According to an embodiment of the present disclosure, a radio opaque penetrant formulation may comprise a penetrating liquid and a radio opaque material. The penetrating liquid may be fluorescent or non-fluorescent. The radio opaque material may comprise at least one of the following metals: barium, bismuth, calcium, cerium, chromium, erbium, gadolinium, gold, lanthanum, lead, mercury, molybdenum, niobium, neodymium, palladium, platinum, plutonium, silver, strontium, tantalum, terbium, thallium, thorium, titanium, tungsten, uranium, vanadium, ytterbium, yttrium, and zirconium. Metals in the radio opaque material may be present in the form of a compound. For example, the radio opaque material may comprise at least one of the following compounds: barium sulfate, bismuth subcarbonate, bismuth (III) sulfide, bismuth trioxide, bismuth oxychloride, sodium metatungstate, sodium polytungstate, tungstate hexasodium, hexamethyltungsten, strontium bromide, zirconium (IV) sulfate, sodium molybdate, silver nitrate, neodymium nitrate, neodymium chloride gadolinium (III) chloride, gold (III) chloride, mercury (II) chloride, thallium (I) hydroxide lead (II) nitrate, lead (II) acetate, bismuth (III) sulfate, thorium (IV) hydroxide, uranyl chloride, plutonium (IV) nitrate, tris(acetyltonato)titanium(III), silver perchlorate, and tantalum (V) ethoxide.

According to certain aspects of the present disclosure, the radio opaque penetrant formulation may comprise between 0.1 and 20, or between 1 and 15, or between 5 and 15, or between 8 and 12, or 10 wt. % of the penetrating liquid; between 0.01 and 80, or between 5 and 50, or between 10 and 25, or between 12 and 20, and 15 wt. % of the radio opaque material; and balance water, oil, and surfactants. In a water-based formulation, the balance may be water and surfactants, with no oil. The surfactants may be ionic or non-ionic.

According to certain aspects of the present disclosure, the penetrating liquid may be fluorescent and may thus comprise a fluorescent dye or other fluorescing material. According to certain aspects of the present disclosure, the fluorescent dye or other fluorescing material may be or include 1H-Benz(de)isoquinoline-1,3(2H)-dione, 2-butyl-6-(butylamino)- (also known as C.I. Solvent Yellow 43). The penetrating liquid may further comprise a fluorescent brightener. According to certain aspects of the present disclosure, the fluorescent brightener may be or include 7-Diethylamino-4-methylcoumarin (also known as Coumarin 1 or C.I. Fluorescent Brightener 140). In certain other aspects of the present disclosure, the penetrating liquid may not be fluorescent.

According to certain aspects of the present disclosure, the penetrating liquid may include dyes and brighteners. Non-limiting examples of these dyes and brighteners include one or more of a fluorescent dye, a visible dye, or a dye free formula. The fluorescent dyes may include solvent yellows and/or optical brighteners. The visible dyes can include rhodamines and azo group dyes.

According to certain aspects of the present disclosure, the penetrating liquid may include surfactants. Example surfactants include one or more anionic surfactant, nonionic surfactant, cationic surfactant, and zwitterionic surfactant. According to certain aspects of the present disclosure, the surfactant includes sodium laureth sulfate, alcohol ethoxylates, sorbitans, alkanaolamides, alkyl amine salts, and cocamides.

According to certain aspects of the present disclosure, the penetrating liquid may also include a base. The base may be one or more of an oil base, a water base, or a solvent base. According to certain aspects of the present disclosure, the oil base may be one or more of paraffinic, naphthenic, synthetic, aliphatic, or vegetable base. According to certain aspects of the present disclosure, the water base may be water and solvent azeotropes formulations. According to certain aspects of the present disclosure, the solvent base may be one or more of isopropyl alcohol, acetone, aromatics, or n-butyl propionate. According to an aspect of the present disclosure, instead of or in addition to scanning a part using an X-ray CT scanner, inspection using a penetrating liquid may involve illuminating the part with an ultraviolet lamp and visually inspecting the part for visible indications.

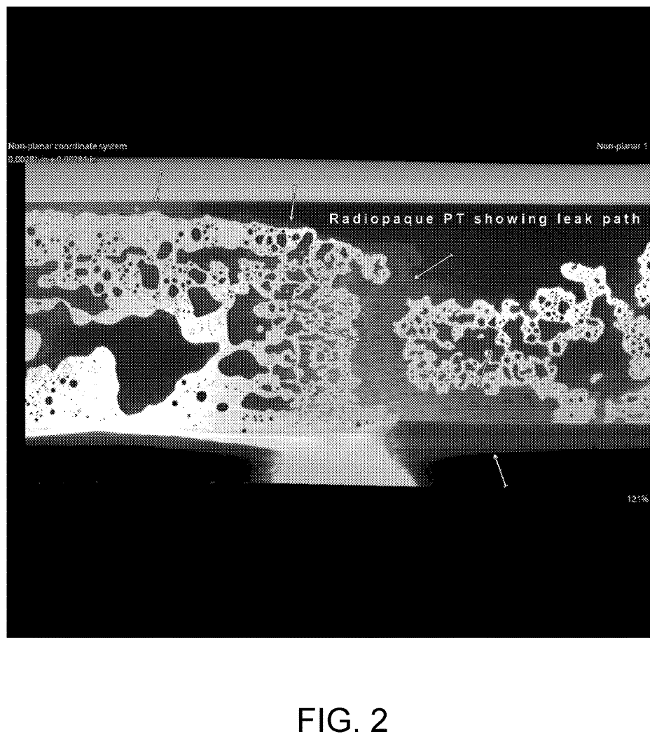

FIG. 2 illustrates an X-ray CT scan of a solder joint between a brass fixture and a copper pipe. The solder is a silver amalgam. A liquid penetrant formulation according to the present disclosure was applied to the crown of the solder joint and allowed to flow into the leak path. Arrows indicate the progression of the liquid penetrant formulation.

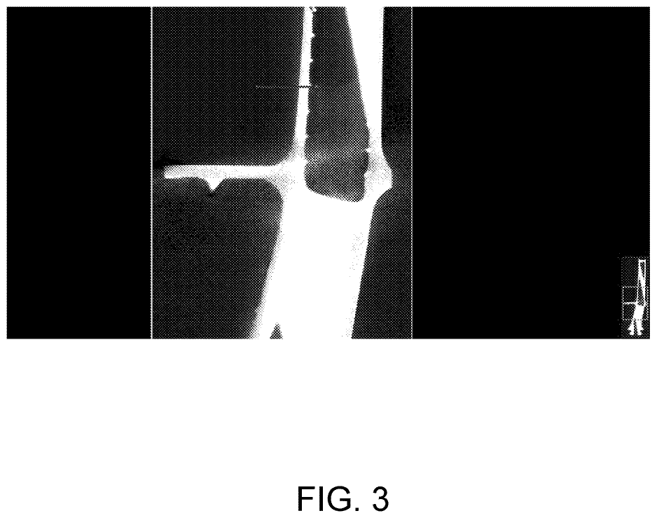

FIG. 3 illustrates an X-ray CT scan of a turbine blade. This figure shows a side 2D slice of the turbine blade showing the liquid penetrant formulation fill level inside the flow vanes. The arrow points to the meniscus.

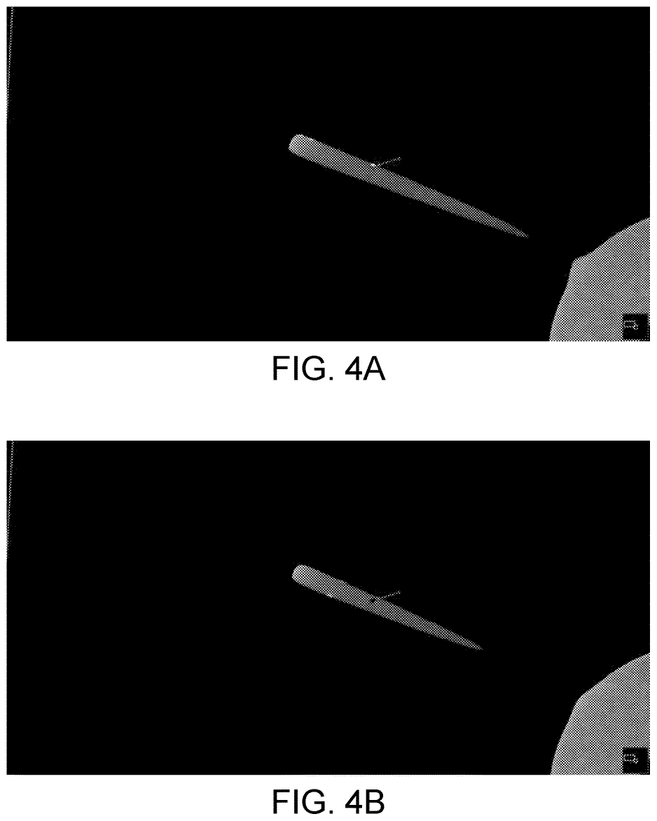

FIG. 4A illustrates an X-ray CT scan of a rotor vane. The arrow indicates a bright spot where liquid penetrant formulation according to the present disclosure has filled a surface accessible flaw. FIG. 4B illustrates another X-ray CT scan of the same rotor vane, imaged several microns down from the image shown in FIG. 4A. The dark spot indicated by the arrow is a void not accessible to the surface. Without the liquid penetrant formulation visible in FIG. 4A, these flaws appear connected.

According to an aspect of the present disclosure, the part to be inspected may be metallic, polymeric, or ceramic.

Table 1 provides ranges for an example radio opaque penetrant formulation according to the present disclosure.

TABLE 1

| | Formula No. 1 | Formula No. 2 | Formula No. 3 |
|---|---|---|---|
| Component | (wt. %) | (wt. %) | (wt. %) |
| Radio opaque material | 0.01-80 | 0.01-80 | 0.01-80 |
| Fluorescent dye or | 0.1-5 | 0.1-10 | 0.1-10 |
| fluorescing material | | | |
| Fluorescent brightener | 0.1-10 | 0.1-10 | — |
| Water | 0-80 | 0-40 | 0-20 |
| Base oil | — | — | 0-50 |
| Surfactants | Balance | Balance | Balance |

Although non-destructive testing options are considered in FIGS. 2-4B, the radio opaque penetrant formulation can also be used in destructive testing as a standard fluorescent penetrant. Further, the formulations as described above can also be used for fluorescent penetrant inspection. The formulations as described above can also be used for leak path identification. The formulations as described above can also be used for surface porosity inspection.

The various aspects and embodiments disclosed herein are not intended to be limiting. Other embodiments may be utilized, and other changes may be made, without departing from the spirit or scope of the subject matter presented herein. It will be readily understood that the aspects of the present disclosure, as generally described herein and illustrated in the figures, can be arranged, substituted, combined, separated, and designed in a wide variety of different configurations, all of which are contemplated herein.

What is claimed is:

1. A method for inspecting and testing a part using a radio opaque penetrant formulation comprising steps of:
a) providing a part;
b) applying a radio opaque penetrant formulation to the part;
c) waiting a period of time to allow the radio opaque penetrant formulation to penetrate into the part; and
d) scanning the part using an X-ray CT scanner;
wherein the radio opaque penetrant formulation comprises a penetrating liquid and a radio opaque material.

2. The method of claim 1, further comprising, prior to applying the radio opaque penetrant formulation in step (b), steps of:
precleaning the part with a cleaning solution; and
drying the part.

3. The method of claim 1, further comprising, subsequent to waiting in step (c), a step of:
removing excess radio opaque penetrant formulation.

4. The method of claim 1, further comprising, prior to scanning in step (d), a step of:
rinsing the part.

5. The method of claim 1, wherein the penetrating liquid is fluorescent.

6. The method of claim 1, wherein the penetrating liquid is non-fluorescent.

7. The method of claim 1, wherein the radio opaque material comprises at least one of the following metals: barium, bismuth, calcium, cerium, chromium, erbium, gadolinium, gold, lanthanum, lead, mercury, molybdenum, niobium, neodymium, palladium, platinum, plutonium, silver, strontium, tantalum, terbium, thallium, thorium, titanium, tungsten, uranium, vanadium, ytterbium, yttrium, and zirconium.

8. The method of claim 7, wherein the radio opaque material comprises at least one of the following compounds: barium sulfate, bismuth subcarbonate, bismuth (III) sulfide, bismuth trioxide, bismuth oxychloride, sodium metatungstate, sodium polytungstate, tungstate hexasodium, hexamethyltungsten, strontium bromide, zirconium (IV) sulfate, sodium molybdate, silver nitrate, neodymium nitrate, neodymium chloride gadolinium (III) chloride, gold (III) chloride, mercury (II) chloride, thallium (I) hydroxide lead (II) nitrate, lead (II) acetate, bismuth (III) sulfate, thorium (IV) hydroxide, uranyl chloride, plutonium (IV) nitrate, tris(acetyltonato)titanium(III), silver perchlorate, and tantalum (V) ethoxide.

9. The method of claim 1, wherein the radio opaque penetrant formulation comprises: between 0.1 and 20 wt. % of the penetrating liquid, between 0.01 and 80 wt. % of the radio opaque material, and balance water, oil, and surfactants.

10. The method of claim 1, wherein the radio opaque penetrant formulation comprises: between 1 and 15 wt. % of the penetrating liquid, between 5 and 50 wt. % of the radio opaque material, and balance water, oil, and surfactants.

11. The method of claim 1, wherein the radio opaque penetrant formulation comprises: between 5 and 15 wt. % of the penetrating liquid, between 10 and 25 wt. % of the radio opaque material, and balance water, oil, and surfactants.

12. The method of claim 1, wherein the period of time in step (b) is between 1 minute and 60 minutes.

13. The method of claim 1, wherein the period of time in step (b) is between 1 hour and 12 hours.

14. The method of claim 1, wherein the scanning step comprises conducting a 2-dimensional X-ray scan.

15. The method of claim 1, wherein the scanning step comprises conducting a 3-dimensional X-ray scan.

16. The method of claim 1, wherein the part is metallic.

17. The method of claim 1, wherein the part is polymeric.

18. The method of claim 1, wherein the part is ceramic.

19. A method for inspecting and testing a part using a radio opaque penetrant formulation comprising the steps of:
a) providing a part;
b) applying a radio opaque penetrant formulation to the part;
c) waiting a period of time to allow the radio opaque penetrant formulation to penetrate into the part; and
d) inspecting the part using an ultraviolet lamp;
wherein the radio opaque penetrant formulation comprises a penetrating liquid and a radio opaque material, and
wherein the penetrating liquid is fluorescent.
